(19) United States
(12) Patent Application Publication
(10) Pub. No.: US 2020/0048095 A1
(43) Pub. Date: Feb. 13, 2020

(54) METHODS FOR PRODUCING CARBON MATERIAL-GRAPHENE COMPOSITE FILMS

(71) Applicant: SABIC Global Technologies B.V., Bergen op Zoom (NL)

(72) Inventors: Lijing Xie, Taiyuan (CN); Ihab N. Odeh, Sugar Land, TX (US); Guohua Sun, Taiyuan (CN); Chengmeng Chen, Taiyuan (CN); Yunyang Liu, Thuwal (SA); Fangyuan Su, Taiyuan (CN)

(21) Appl. No.: 16/340,608

(22) PCT Filed: Oct. 10, 2017
(86) PCT No.: PCT/IB2017/056256

§ 371 Date: Apr. 9, 2019

(30) Foreign Application Priority Data
Oct. 18, 2016 (CN) 201610908001.5

(51) Int. Cl. C01B 32/198; C01B 32/318; C01B 32/372; H01G 11/36; H01G 11/40; H01G 11/44; H01M 4/36; H01M 4/583

(52) U.S. Cl. CPC C01B 32/198; H01M 10/0525; C01B 32/372; H01G 11/36; H01G 11/40; H01G 11/44; H01M 4/362; H01M 4/583; C01P 2002/70; C01P 2004/03; C01P 2004/04; C01P 2006/12; C01P 2006/16; C01P 2006/40; C01B 32/318

(57) ABSTRACT

Methods for producing a carbon material-graphene composite are described. A method can include obtaining a dispersion comprising a graphene oxide material and a carbon material dispersed in a liquid medium, evaporating the liquid medium to form a carbon material-graphene composite precursor, and annealing the composite precursor at a temperature of 800° C. to 1200° C. in the presence of an inert gas to form the carbon material-graphene composite. The graphene oxide material can be grafted graphene oxide. Flexible carbon material-graphene composites are also described. The composites can have a polyacrylonitrile (PAN)-based activated carbon attached to a graphene layer, have a surface area of 1500 m²/g to 2250 m²/g, and a bimodal porous structure of micropores and mesopores.

### CROSS REFERENCE TO RELATED APPLICATIONS

This application claims benefit to Chinese Patent Application No. 201610908001.5 filed Oct. 18, 2016, which is incorporated herein in its entirety.

### BACKGROUND OF THE INVENTION

### A. Field of the Invention

The invention generally concerns methods of producing an activated carbon material-graphene composite, which can be in the form of a flexible material (e.g., film, layer, substrate, etc.). The activated carbon material can be derived from polyacrylonitrile (PAN)-based activated carbon. The composites of the invention can be used in a variety of applications (e.g., catalysts for chemical reactions, energy storage and conversion, actuators, piezo-devices, sensors, smart textile, flexible devices, electronic and optical devices, high-performance nanocomposites, etc.).

### B. Description of Related Art

As a two-dimensional crystal of sp² conjugated carbon atoms, graphene possesses a large surface area of 2630 m²/g and a corresponding specific capacitance up to 263-526 F/g. Graphene-based films can be used as a flexible material for various applications. However, due to the low bulk density of graphene, binders are typically used to bind the graphene together when fabricating electrode materials. The incorporation of large amounts of binder in graphene composite electrodes can result in inferior electrochemical performance as compared to traditional carbon materials.

Various attempts have been made to developed graphene composite films that can meet acceptable performance levels. For example, Chinese Patent Publication No. 102329424 to Zhao et al., describes preparation of a homogenous electrolyte by adding powered graphene and pyrrole monomer into the solution of sodium diethylhexyl sulfosuccinate followed by ultrasonic dispersion. An electrochemical process was used to prepare the resulting composite film. Although the as-prepared composite film exhibited high capacity, the film had an inferior cyclic stability, which limited its practical application in energy storage devices. In another example, Chinese Patent Publication No. 103103492 to Qiao et al., describes preparation of a carbon nanotube (CNT)/graphene composite film through a catalyst decomposition and catalytic cracking process. While the composite film exhibited high electric conductivity, it had a lower specific surface area, thereby limiting its application in energy storage devices. In still another example, Zhang et al., Fibrous and flexible supercapacitors comprising hierarchical nanostructures with carbon spheres and graphene oxide nanosheets, J. Mater. Chem. A, 2015, Vol. 3, pp. 12761-12768, synthesized nanospheres derived from cellulose, and then prepared a carbon spheres/graphene composite film by electrochemical processing methods. This resulted in a lower specific surface area film, thereby limiting the film's use in energy storage applications.

Many of the current methods used to produce graphene composite materials for use in energy storage applications fail to result in materials that have desired characteristics such as good capacitance, appropriate cyclic stability, high electric conductivity, and/or high specific surface area.

Attempts to remove or lower the amounts of binder in graphene film have been numerous. By way of example, Chinese Patent No. 104354447 to Wang et al. describes a method for preparation of thermally conductive graphene composite film that uses alkali metal salts to convert the graphene oxide to graphene. However, due to the tremendous interlayer van der Waals attractions, irreversible re-stacking or aggregation among graphene sheets tends to occur, thus making of the use of alkali metal salts difficult.

### SUMMARY OF THE INVENTION

A discovery has been made that provides a solution to the aforementioned problems associated with producing flexible graphene composite materials (e.g., films, layers, substrates, etc.) that can be used in energy storage applications. The solution lies in an elegant method that utilizes a liquid medium evaporation-induced self-assembly of a composite material. The liquid medium includes graphene oxide, preferably grafted graphene oxide, and a carbon material (e.g., an activated carbon nanostructure such as nanoparticles or nanofibers, preferably polyacrylonitrile (PAN)-based activated carbon nanofibers or nanoparticles). Without wishing to be bound by theory, it is believed that the volatility of the liquid medium promotes the self-assembly of a composite film having the graphene oxide and carbon material. Supports and binders do not have to be used with the processes of the present invention. The self-assembly can be further induced in instances where there is a different Zeta potential for the graphene oxide and the activated carbon material. Once the self-assembled film is formed, it can then be annealed (e.g., temperature of 800° C. to 1200° C.) to produce a carbon material-graphene composite of the present invention that can be binder-free and/or support-free. Notably, this process can be used to produce flexible carbon material—graphene composites that have any one or all of the following features: (1) high specific surface area, (2) good electric conductivity, (3) good capacitance, (4) good energy density, (5) good power density, and/or (6) cyclic stability. The resulting graphene composites can be used in a variety of energy storage applications (e.g., capacitors, supercapacitors, lithium-ion batteries, etc.).

In a particular aspect of the invention, a method for producing a carbon material-graphene composite is described. The method can include: (a) obtaining a dispersion that can include a graphene oxide material (e.g., graphene oxide and/or grafted graphene oxide) and a carbon material dispersed in a volatile liquid medium (e.g., alcohol, preferably methanol, ethanol, propanol, butanol, or combinations thereof); (b) evaporating the liquid medium to form a carbon material-graphene composite precursor; and (c) annealing the composite precursor at a temperature of 800° C. to 1200° C. in the presence of an inert gas to form the carbon material-graphene composite of the present invention. Functional groups (e.g., nitrogen groups) grafted on the graphene oxide can facilitate dispersion of the graphene oxide in the liquid medium and/or enhance the affinity of the graphene oxide with the carbon material. In a preferred embodiment, the carbon material is polyacrylonitrile (PAN)-based carbon material (e.g., PAN-based carbon nanostructures, PAN-based carbon fibers, or both) and/or the graphene oxide material is grafted graphene oxide. The nanostructures can have a variety of shapes (e.g., fibers or nanoparticles), with nanoparticles (e.g., substantially spherical particles) being preferred in some embodiments. The specific surface area of PAN-based carbon nanostructures or PAN-based carbon fibers can be 1800 to 2600 m²/g. The mass ratio of the graphene oxide material, the carbon material, and the liquid medium in step (a) can be 1:1:200, 1:5:200, 1:1:300, or 1:5:300. In some instances, the dispersion in step (a) is obtained by combining the graphene oxide material and the carbon material with the liquid medium and subjecting the liquid medium to ultra-sonication. Step (b) can further include casting the solution on a substrate, and (ii) evaporating the liquid medium, preferably at a temperature of 20° C. to 50° C., more preferably 25° C. to 35° C. As discussed above, evaporation of the liquid medium can promote self-assembly of the graphene oxide material and the carbon material.

In some embodiments, the grafted graphene oxide can be obtained by subjecting a composition that includes an organic solvent, graphene oxide, and a grafting agent to conditions sufficient to produce a grafted graphene oxide, and removing the grafted graphene oxide from the organic solution. The conditions preferably include subjecting the composition to a temperature of 50° C. to 150° C. for 6 to 24 hours, more preferably for 75° C. to 100° C., for 8 to 12 hours. The graphene oxide can be suspended in the solution and the grafting agent can be solubilized in the organic solvent. The graphene can have a lamellar thickness of 3-5 layers and a specific surface area of 600-800 m²/g. Grafting agents can include an ionic liquid (e.g., a guanidine ionic liquid, preferably guanidine hydrochloride, phosphoguanidine, tetramethylguanidine lactate tetramethylguanidine trifluoromethanesulfonic acid, tetramethylguanidine hydrogen sulfate, or tetramethylguanidine hydrochloride, or any combination thereof) and/or a poly-amino compound (e.g., a compound having two or more amino groups, preferably ethylenediamine, triethylenediamine, diethylenetriamine or oligo branched polyethylenimine, or any combination thereof). Mass ratios of the graphene oxide, the grafting reactant, and the organic solvent can be 1:25:200, 1:30:200, 1:25:280, or 1:30:280. Non-limiting examples of polar solvents that can be used in the context of the present invention include dimethylformamide (DMF), dimethylacetamide (DMAc), dimethyl sulfoxide (DMSO), acetonitrile, alcohols, ethanol, water, or any combination thereof.

In another aspect of the invention, a flexible carbon material-graphene composite comprising PAN-based carbon attached to a graphene layer is described. In a preferred instance, the PAN-based carbon is activated. The material can be made by any of the methods of the present invention. The material can have a surface area of 1500 m²/g to 2250 m²/g; and a bimodal porous structure of micropores (e.g., an average size of 0.8 nm to 1.2 nm) and mesopores (e.g., an average size of 2 nm to 5 nm). The material can be a flexible film or sheet, preferably having a thickness of 1 μm to 500 μm, preferably 50 μm to 200 μm, or about 100 μm. In some instances, the material can be a binder-free material and/or a support-free material. The material can include at least two graphene layers that are attached to one another through the PAN-based carbon material (e.g., the PAN-based activated carbon is positioned between the two graphene layers). Electrical properties of the material can include an electrical conductivity of 1 S/cm to 45 S/cm, preferably 4 S/cm to 40 S/cm; an energy density of 10 Wh/kg to 40 Wh/kg, preferably 15 Wh/kg to 35 Wh/kg, or more preferably about 20 Wh/kg; a power density of 5 kW/kg to 15 kW/kg; and/or a specific capacitance of 100 F/g to 140 F/g, preferably 110 F/g to 130 F/g.

In yet another instance, energy devices that include the PAN-based carbon material-graphene composite material are described. The energy device can be an energy storable device such as a capacitor, a supercapacitor, or a rechargeable battery, preferably a lithium-ion or lithium sulfur battery. The PAN-based carbon material-graphene composite can be included in an electrode of the energy storage device, preferably the cathode of the energy storage device. The composite can be used as a flexible film that, as exemplified in the Example Section, exhibits high energy density, high power density, excellent rate capability, and/or flexibility.

In the context of the present invention 30 embodiments are described. Embodiment 1 is a method for producing a carbon material-graphene composite. The method can include (a) obtaining a dispersion comprising a graphene oxide material and a carbon material dispersed in a liquid medium, (b) evaporating the liquid medium to form a carbon material-graphene composite precursor, and (c) annealing the composite precursor at a temperature of 800° C. to 1200° C. in the presence of an inert gas to form the carbon material-graphene composite. Embodiment 2 is the method of embodiment 1, wherein the carbon material is a polyacrylonitrile (PAN)-based carbon material. Embodiment 3 is the method of any one of embodiments 1 or 2, wherein graphene oxide has a lamellar thickness of 3-5 layers and a specific surface area of 600-800 m²/g. Embodiment 4 is the method of any one of embodiments 1 to 3, wherein the graphene oxide material is grafted graphene oxide or graphene oxide. Embodiment 5 is the method of embodiment 4, wherein the grafted graphene oxide is obtained by: (i) subjecting a composition comprising a solvent, graphene oxide, and a grafting agent to conditions sufficient to produce a grafted graphene oxide, the conditions preferably comprise subjecting the composition to a temperature of 50° C. to 150° C., more preferably for 75° C. to 100° C., and (ii) removing the grafted graphene oxide from the solution. Embodiment 6 is the method of embodiment 5, wherein the graphene oxide is suspended in the solution and the grafting agent is solubilized in the solvent. Embodiment 7 is the method of any one of embodiments 5 to 6, wherein the grafting agent comprises an ionic liquid or a poly-amino compound, or both. Embodiment 8 is the method of embodiment 7, wherein the ionic liquid is a guanidine ionic liquid, preferably guanidine hydrochloride, phosphoguanidine, tetramethylguanidine lactate tetramethylguanidine trifluoromethanesulfonic acid, tetramethylguanidine hydrogen sulfate, or tetramethylguanidine hydrochloride, or any combination thereof. Embodiment 9 is the method of embodiment 7, wherein the poly-amino compound comprises a compound having two or more amino groups, preferably ethylenediamine, triethylenediamine, diethylenetriamine or oligo branched polyethylenimine, or any combination thereof. Embodiment 10 is the method of any one of embodiments 5 to 9, wherein the mass ratio of the graphene oxide material, the grafting reactant, and the organic solvent is 1:25:200, 1:30:200, 1:25:280, or 1:30:280. Embodiment 11 is the method of any one of embodiments 5 to 10, wherein the solvent is dimethylformamide (DMF), dimethylacetamide (DMAc), dimethyl sulfoxide (DMSO), acetonitrile, alcohols, ethanol, water, or any combination thereof. Embodiment 12 is the method of any one of embodiments 2 to 11, wherein the PAN-based carbon material is PAN-based carbon nanostructures, PAN-based carbon fibers, or both. Embodiment 13 is the method of embodiment 12, wherein the PAN-based carbon nanostructures are nanoparticles. Embodiment 14 is the method of any one of embodiments 12 to 13, wherein the specific surface area of PAN-based carbon nanostructures or PAN-based carbon fibers is 1800 to 2600 m²/g. Embodiment 15 is the method of any one of embodiments 1 to 14, wherein the mass ratio of the graphene oxide material, the carbon material, and the liquid medium in step (a) is 1:1:200, 1:5:200, 1:1:300, or 1:5:300. Embodiment 16 is the method of any one of embodiment 1 to 15, wherein the liquid medium is an alcohol, preferably methanol, ethanol, propanol, butanol or combinations thereof. Embodiment 17 is the method of any one of embodiment 1 to 16, wherein the dispersion in step (a) is obtained by combining the grafted graphene oxide and the carbon with the liquid medium and subjecting the liquid medium to ultra-sonication. Embodiment 18 is the method of any one of embodiments 1 to 17, wherein step (b) further comprises: (i) casting the solution on a substrate; and (ii) evaporating the liquid medium, preferably at a temperature of 20° C. to 50° C., more preferably 25° C. to 35° C. Embodiment 19 is the method of any one of embodiment 1 to 18, wherein step (b) promotes self-assembly of the grafted graphene oxide and the carbon material.

Embodiment 20 is a flexible carbon material-graphene composite comprising PAN-based activated carbon attached to a graphene layer, wherein the composite has: (a) a surface area of 1500 m²/g to 2250 m²/g; and (b) a bimodal porous structure of micropores and mesopores. Embodiment 21 is the flexible carbon material-graphene composite of embodiment 20, wherein the material is a flexible film or sheet, preferably having a thickness of 1 μm to 500 μm, preferably 50 μm to 200 μm, or about 100 μm. Embodiment 22 is the flexible carbon material-graphene composite of any one of embodiments 20 to 21, wherein the average size of the micropores are 0.8 nm to 1.2 nm and the average size of the mesopores are 2 nm to 5 nm. Embodiment 23 is the flexible carbon material-graphene composite of any one of embodiments 20 to 22, wherein the composite is binder-free and/or support-free. Embodiment 24 is the flexible carbon material-graphene composite of any one of embodiments 20 to 23, wherein the composite comprises at least two graphene layers that are attached to one another through the PAN-based carbon material. Embodiment 25 is the flexible carbon material-graphene composite of embodiment 24, wherein the PAN-based activated carbon is positioned between the two graphene layers. Embodiment 26 is the flexible carbon material-graphene composite of any one of embodiments 20 to 25, wherein the composite includes: an electrical conductivity of 1 S/cm to 45 S/cm, preferably 4 S/cm to 40 S/cm, an energy density of 10 Wh/kg to 40 Wh/kg, preferably 15 Wh/kg to 35 Wh/kg, or more preferably about 20 Wh/kg, a power density of 5 kW/kg to 15 kW/kg, and/or a specific capacitance of 100 F/g to 140 F/g, preferably 110 F/g to 130 F/g. Embodiment 27 is the flexible carbon material-graphene composite of any one of embodiments 20 to 26, wherein the composite is made by the method of any one of embodiments 1 to 19. Embodiment 28 is an energy storage device comprising the carbon material-graphene composite of any one of embodiments 20 to 27. Embodiment 29 is the energy storage device of embodiment 28, wherein the energy storage device is a capacitor, a supercapacitor, or a rechargeable battery, preferably a lithium-ion or lithium sulfur battery. Embodiment 30 is the energy storage device of any one of embodiments 28 to 29, wherein the carbon material-graphene composite is comprised in an electrode of the energy storage device, preferably the cathode of the energy storage device.

The following includes definitions of various terms and phrases used throughout this specification.

“Graphene materials” include single-layer graphene, two-layers graphene, multi-layers graphene, graphene oxide, reduced graphene oxide and modified graphene.

“Graphene composite” or “Graphene composite material” refers to a material that includes graphene and another material. By way of example, a carbon material-graphene composite of the present invention includes graphene or graphene oxide and a carbon material. The carbon material is not graphene or graphene oxide. Non-limiting examples of carbon material-graphene composites of the present invention are illustrated in FIGS. 1, 4, 5E, and 5F.

“Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof. “Nanoparticles” include particles having an average diameter size of 1 to 1000 nanometers.

“Microstructure” refers to an object or material in which at least one dimension of the object or material is greater than 1000 nm (e.g., greater than 1000 nm up to 5000 nm) and in which no dimension of the structure is 1000 nm or smaller. The shape of the microstructure can be of a wire, a particle (e.g., a substantially spherical-shaped particle), a rod, a tetrapod, a hyper-branched structure, a tube, a cube, or mixtures thereof. “Microparticles” include particles having an average diameter size of greater than 1000 nm, preferably greater than 1000 nm to 5000 nm, or more preferably greater than 1000 nm to 10000 nm.

“Carbon material” refers to a compound or composition that is manufactured from a hydrocarbon material. “Hydrocarbons” include carbon atoms and hydrogen atoms, and optionally, heteroatoms (e.g., nitrogen atoms, oxygen atoms, sulfur atoms, phosphorous atoms), halogens, or any combinations thereof. The carbon material can be in the form of nanostructures (e.g., nanofibers or nanoparticles). The carbon material can be activated. “Activated carbon” or “active carbon” refer to a carbon material that has been processed to have small, high-volume pores. A preferred “activated carbon material” or “active carbon material” includes activated PAN-based carbon nanostructures (e.g., nanofibers or substantially spherical nanoparticles). Other non-limiting examples include nanostructures made from isotropic pitch, polyacrylonitrile, rayon, cotton stalk, coconut shell, wood, paper, biomass, and/or heavy oils having a pore size of 0.5 nm to 3 nm.

“Zeta Potential” refers to the electrical potential difference across phase boundaries between solids and liquids. By way of example, it a measure of electrical charge of particles that are present in a liquid medium.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The methods and composites of the present invention can “comprise,” “have,” “include,” “consist essentially of” or “consist of” particular ingredients, components, compositions, etc. disclosed throughout the specification. With respect to the transitional phase “consisting essentially of” in one non-limiting aspect, a basic and novel characteristic of the composites of the present invention is that they can have high specific surface area, good electric conductivity, good capacitance, good energy density, good power density, and/or have cyclic stability. The processes of the present invention can also allow for the preparation of composites that are binder-free and/or non-supported.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a schematic of a method of the present invention to produce flexible carbon material-graphene composites of the present invention.

FIG. 2 is an atomic force microscope (AFM) image of graphene oxide (GO) microstructures.

FIG. 3 is a transmission electronic microscope (TEM) image of activated carbon fibers (ACF).

FIG. 4 is a scanning electron microscope (SEM) image of a flexible carbon material-graphene composite of the present invention.

FIGS. 5A-F are SEM images of ACF (5A and 5B), a comparative reduce GO film (5C and 5D), and a flexible carbon material-graphene composite of the present invention (5E and 5F).

FIG. 6A shows N₂ adsorption-desorption isotherms of ACF and a carbon material-graphene composite of the present invention (ACF-rGO-2).

FIG. 6B shows nonlocal density functional theory (DFT) pore size distribution of ACF and a carbon material-graphene composite of the present invention.

FIG. 6C shows a pore size distribution of activated carbon derived from PAN fiber.

FIG. 6D shows a pore size distribution of comparative activated carbon derived from petrol coke.

FIG. 7 shows thermal gravimetric analysis (TGA) curves of GO, ACF, and a carbon material-graphene composite of the present invention.

FIG. 8 shows the X-ray diffraction (XRD) patterns for Example 1 ACF and Example 11 ACF-rGO-2 of the present invention.

FIGS. 9A-D show the electrochemical performance of the as-fabricated flexible supercapacitor (ACF-rGO-2 composite material of the present invention, Example 11) with 1.0 M Et₄NBF₄/PC as the electrolyte. FIG. 9A: CV curves of ACF-rGO-2 of the present invention at a voltage window range from 0 to 2.7 at different scan rates. FIG. 9B: GCD curves of ACF-rGO-2 of the present invention at different current densities. FIG. 9C specific capacitance vs. current densities for ACF-rGO-2 of the present invention. FIG. 9D: power density vs. energy density for ACF-rGO-2 of the present invention.

FIG. 10 shows Nyquist plots of a carbon material-graphene composite of the present invention in the frequency range from 0.01 Hz to 10⁵ Hz.

FIGS. 11A-C shows performance of a carbon material-graphene composite of the present invention in a packaged flexible device. FIG. 11A: image of flexible supercapacitor lighting an LED bulb. FIG. 11B: cycling stability of ACF-rGO-2 at a current density of 1 A g⁻¹. FIG. 11C: specific capacitance vs. bending cycles for ACF-rGO-2.

While the invention is susceptible to various modifications and alternative forms, specific embodiments thereof are shown by way of example in the drawings. The drawings may not be to scale.

### DETAILED DESCRIPTION OF THE INVENTION

The currently available graphene composite materials (e.g., films) require binders or adhesives to bond the graphene materials together to from a composite thin film. These binders or adhesives reduce the electrochemical performance as compared to traditional carbon materials. A discovery has been made that allows preparation of binder-free or non-supported carbon material-graphene composites. The discovery is premised on choosing a graphene oxide material and a carbon material that have different Zeta potentials such that homogenous self-assembly can be induced. The Zeta potentials for graphene oxide, activated carbon fiber and PAN carbon nanospheres are −43, +15, +20, respectively. The self-assembly is promoted by evaporation of a solvent at mild temperatures from a solution containing the graphene oxide and the carbon material. The carbon material can be an activated carbon fiber, preferably a polyacrylonitrile (PAN)-based activated carbon fiber. The method provides an elegant way to produce carbon material-graphene composites having high specific surface area and/or high electric conductivity, thereby making them suitable for use in the field of supercapacitors and lithium-ion batteries. Other features that the composites of the present invention can have include high capacitance, high energy density, high power density, and/or cyclic stability.

These and other non-limiting aspects of the present invention are discussed in further detail in the following sections.

A. Preparation of Carbon Material-Graphene Composites

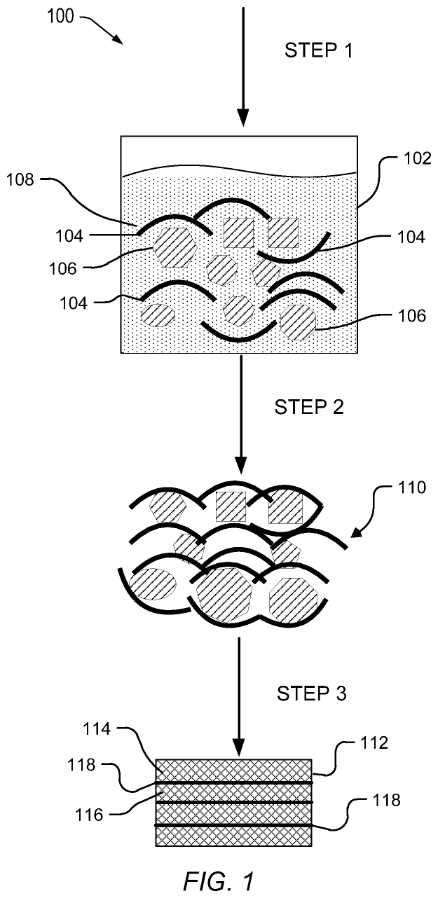

FIG. 1 is a schematic of a process for preparing carbon material-graphene composites of the present invention. The method can include one or more steps that can be used in combination to make a multi-structured composite material that can be used in energy storage device applications.

Referring to method 100 of FIG. 1, in step 1 of the method a dispersion 102 that includes graphene oxide material 104 and a carbon material 106 dispersed in a liquid medium 108 can be obtained. The graphene oxide material 104 can be prepared as described in the Materials Section below, the Examples Section, or obtained from a commercial vendor. The carbon material 106 can be any carbon material. Preferably active carbon material is used. The liquid medium 108 can be any alcohol. Non-limiting examples of alcohols include methanol, ethanol, propanol, butanol or combinations thereof. In one instance, the dispersion is grafted graphene oxide, activated polyacrylonitrile carbon nanostructures (e.g., nanoparticles such as substantially spherical particles or nanofibers) dispersed in methanol. The graphene oxide material and carbon material can be added to the liquid medium under mechanical stirring or sonication (e.g., ultra-sonication) until the dispersion is homogeneous or substantially homogeneous. Ultrasonic dispersion in water can prevent graphene oxide material (e.g., GO flakes or grafted graphene oxide material) and carbon material (e.g., turbostratic microcrystalline structure) from aggregating to get a homogeneous dispersion.

A mass ratio of the graphene oxide material 104, the carbon material 106, and the liquid medium 108 can range from 1:1:200, 1:5:200, 1:1:300, or 1:5:300. The mass ratio of the graphene oxide material 104 to the carbon material 106 can range from 1:1 to 1:5, or about 1:1, 1:1.1, 1:1.2, 1:1.3, 1:1.4, 1:1.5, 1:1.6, 1:1.7, 1:1.8, 1:1.9, 1:2, 1:2.1, 1:2.2, 1:2.3, 1:2.4, 1:2.5, 1:2.6, 1:2.7, 1:2.8, 1:2.9, 1:3, 1:3.1, 1:3.2, 1:3.3, 1:3.4, 1:3.5, 1:3.6, 1:3.7, 1:3.8, 1:3.9, 1:4.0, 1:4.1, 1.4.2, 1:4.3, 1:4.4, 1:4.5, 1:4.6, 1:4.7, 1:4.8, 1:4.9, or 1:5, preferably 1:2. The mass ratio of the graphene oxide material 104 to the liquid medium 108 can range from 1:200 to 1:300, or 1:200, 1:210, 1:220, 1:230, 1:240, 1:250, 1:260, 1:270, 1:280, 1:290, or 1:300.

In step 2 of the method 100, the liquid medium 108 can be removed from the dispersion 102 to promote formation of a carbon material-graphene oxide composite precursor 110. Removal of the liquid medium can occur by contacting the dispersion 102 with a substrate. By way of example, the dispersion 102 can be vacuum filtered through a microporous membrane material and the carbon material-graphene oxide composite precursor 110 can be removed (e.g. peeled) from the microporous membrane material. In some instances, the composite precursor 110 can be dried at room temperature. In yet another example, the dispersion 102 can be cast on a substrate (e.g., a glass substrate), and the liquid medium can be removed at a temperature of 20° C. to 50° C. or 25° C. to 35° C., or about 20° C., 25° C., 30° C., 35° C., 40° C., 45° C., or 50° C. Removal of the solvent can promote self-assembly of the graphene oxide material 104 and the carbon material 106 into a composite precursor 110 that has the carbon material in between the layers of the graphene oxide material. In the solvent removal stage of the process, both graphene oxide material 104 and carbon material 106 are deposited in a disorderly manner onto the surface of a substrate (e.g., a glass substrate or membrane). Without wishing to be bound by theory, it is believed that the carbon material-graphene composite precursor 110 can be formed relying on overlapping of flexible graphene oxide material sheets, in which the graphene oxide material 104 and the carbon material 106 can be regarded as the ‘concrete’ and ‘rebar’, respectively.

In step 3 of the method, the composite precursor 110 can be heat-treated under an inert atmosphere to form the carbon material-graphene composite material 112. Heat-treating the composite precursor 110 under inert atmosphere reduces the graphene oxide to graphene. Without wishing to be bound by theory, it is believed that annealing the carbon material-graphene composite precursor can partially repair the lattice defect of graphene oxide and enhance the electrical conductivity of integral material. In some embodiments, the composite precursor can be positioned between two inert plates (e.g., graphite mold) and placed in a heating unit (e.g., tubular furnace), and then heated at a temperature of 800° C. to 1200° C., or 900° C. to 1100° C., or 950° C. to 1000° C., or 925° C. to 975° C., or about 950° C. A rate of heating can range from 1 to 10° C. per minute, or 2 to 8° C. per minute or about 5° C. per minute. A flow of inert gas (e.g., argon) can be 20 mL per minute (mL min⁻¹) to 40 mL min⁻¹ or 25 mL min⁻¹ to 35 mL min⁻¹, or about 30 mL min⁻¹.

The resulting flexible carbon material-graphene composite can be flexible, porous, and/or have textural and electrical conductivity properties suitable for use in many devices or materials. Composite 112 has graphene layers 114 and 116 attached to one another through the carbon material 118 (e.g., PAN-based carbon material derived from nanoparticles or nanofibers of PAN).

B. Flexible Carbon Material-Graphene Composites

The resulting flexible carbon material-graphene composite can be flexible, have a surface area of a surface area of 1500 m²/g to 2250 m²/g, and/or a bimodal porous structure of micropores and mesopores. Notably, the composite can be binder-free material and/or support-free. The composite has at least two graphene layers and/or grafted graphene attached to one another through the carbon material (e.g., PAN-based activated carbon material). The surface area can range from 1500 m²/g to 2250 m²/g, 1600 m²/g to 2100 m²/g, 1700 m²/g to 2000 m²/g, or about 1500 m²/g, 1525 m²/g, 1550 m²/g, 1575 m²/g, 1600 m²/g, 1625 m²/g, 1650 m²/g, 1675 m²/g, 1700 m²/g, 1725 m²/g, 1750 m²/g, 1775 m²/g, 1800 m²/g, 1825 m²/g, 1850 m²/g, 1875 m²/g, 1900 m²/g, 1975 m²/g, 2000 m²/g, 2025 m²/g, 2050 m²/g, 2075 m²/g, 2100 m²/g, 2125 m²/g, 2150 m²/g, 2175 m²/g, 2200 m²/g, 2225 m²/g, or 2250 m²/g. The composite 22 can be a flexible film or sheet and have 1 μm to 500 μm, preferably 50 μm to 200 μm, or about 100 μm, or about 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm 195 μm, or 200 μm. An average size of the micropores can be 0.8 nm to 1.2 nm, or about 0.8 nm, 0.85 nm, 0.90 nm, 0.95 nm, 1.0 nm, 1.05 nm, 1.1 nm, 1.15 nm, or 1.2 nm. An average size of the mesopores can be 2 nm to 5 nm, or about 2 nm, 2.5 nm, 3.0 nm, 3.5 nm, 4.0 nm, 4.5 nm, or 5 nm. In some embodiments, the composite 22 is a flexible PAN-based activated carbon material-graphene composite material and has the following electrical properties: (1) an electrical conductivity of 1 S/cm to 45 S/cm, preferably 4 S/cm to 40 S/cm, or about 4 S/cm, 5 S/cm, 6 S/cm, 7 S/cm, 8 S/cm, 9 S/cm, 10 S/cm, 11 S/cm 12 S/cm, 13 S/cm, 14 S/cm, 15 S/cm, 16, S/cm, 17 S/cm, 18 S/cm, 19 S/cm, 20 S/cm, 21 S/cm, 22 S/cm, 23 S/cm, 24 S/cm, 25 S/cm, 26 S/cm, 27 S/cm, 28 S/cm, 29 S/cm, 30 S/cm, 31 S/cm, 32 S/cm, 33 S/cm, 34 S/cm, 35 S/cm, 36 S/cm 37 S/cm 38 S/cm, 39 S/cm, 40 S/cm, 41 S/cm 42 S/cm 43 S/cm, 44 S/cm or 45 S/cm; (2) an energy density of 10 Wh/kg to 40 Wh/kg, preferably 15 Wh/kg to 35 Wh/kg, or more preferably about 20 Wh/kg, or about 10 Wh/kg, 15 Wh/kg, 20 Wh/kg, 25 Wh/kg, 30 Wh/kg, 35 Wh/kg, or 40 Wh/kg; (3) a power density of 5 kW/kg to 15 kW/kg, or about 5 kW/kg, 6 kW/kg, 7 kW/kg, 8 kW/kg, 9 kW/kg, 10 kW/kg, 11 kW/kg, 12 kW/kg, 13 kW/kg, 14 kW/kg or 15 kW/kg; and/or (4) a specific capacitance of 100 F/g to 140 F/g, preferably 110 F/g to 130 F/g, or about 100 F/g, 110 F/g, 115 F/g, 120 F/g, 125 F/g, 130 F/g, 135 F/g, or 140 F/g.

C. Graphene Oxide and Carbon Materials

1. Graphene Oxide Materials

The graphene oxide material can be grafted graphene oxide or graphene oxide. The grafted graphene oxide can be obtained from using the method described below. Graphene oxide can be obtained from various commercial sources or prepared as exemplified in the Example section by modification of known literature methods (e.g., Hummers et al., J. Am. Chem. Soc., 1958, 80, 1339-1339, which is incorporated by reference). The graphene oxide can have a lamellar thickness of 3-5 layers (3, 4, or 5 layers) and a specific surface area of 600-800 m²/g or 650 to 750 m²/g, or about 600 m²/g, 625 m²/g, 650 m²/g, 675 m²/g, 700 m²/g, 725 m²/g, 750 m²/g, 775 m²/g, or 800 m²/g, Grafting agents and solvents can be obtained from various commercial sources such as Sigma-Aldrich® (U.S.A.).

The grafted graphene oxide can be prepared by subjecting a composition that includes a solvent, graphene oxide, and a grafting agent to conditions sufficient to produce a grafted graphene oxide, and then removing the grafted graphene oxide from the solvent. The grafting agent can include an ionic liquid or a poly-amino compound, or both. Non-limiting examples of ionic liquids include guanidine ionic liquids such as guanidine hydrochloride, phosphoguanidine, tetramethylguanidine lactate tetramethylguanidine trifluoromethanesulfonic acid, tetramethylguanidine hydrogen sulfate, or tetramethylguanidine hydrochloride, or any combination thereof. In a preferred instance, guanidine hydrochloride is used. Non-limiting examples of poly-amino compounds include a compound having two or more amino groups such as ethylenediamine, triethylenediamine, diethylenetriamine or oligo branched polyethylenimine (polyPEl), or any combination thereof. Suitable solvents include dimethylformamide (DMF), dimethylacetamide (DMAc), dimethyl sulfoxide (DMSO), acetonitrile, alcohols, ethanol, water, or any combination thereof. The mass ratio of the graphene oxide, the grafting reactant, and the organic solvent can be 1:25:200, 1:30:200, 1:25:280, or 1:30:280. The mass ratio of the graphene oxide and the grafting agent can be 1:25 to 1:30, or about 1:25, 1:25.1, 1:25.2, 1:25.3, 1:25.4, 1:25.5, 1:25.6, 1:25.7, 1:25.8, 1:25.9, or 1:30. The mass ratio of graphene oxide to the solvent can be 1:200 to 1:280, or about 1:200, 1:210, 1:220, 1:230, 1:240, 1:250, 1:260, 1:270, or 1:280. The grafting agent and graphene oxide can be added to the organic solvent under agitation to form a dispersion. In a preferred instance, graphene oxide, guanidine hydrochloride and dimethylformamide are used. The dispersion can be heated to 50° C. to 150° C., more preferably for 75° C. to 100° C., or about 50° C., 55° C., 60° C., 65° C., 70° C., 75° C., 80° C., 85° C., 90° C., 95° C., 100° C., 110° C., 115° C., 120° C., 125° C., 130° C., 135° C., 140° C., 145° C., or 150° C. and held at this temperature until a sufficient amount of the grafting agent reacts with the graphene oxide (e.g., 8 to 12 hours, or about 8, 9, 10 11, 12 hours). During heating, the grafting agent can be completely or substantially solubilized (e.g., dissolved) in the solvent, while the graphene oxide is suspended or dispersed in the solvent.

2. Carbon Material

The carbon material can be a carbonized hydrocarbon derived from polyacrylonitrile, polyvinyl alcohol, polymethylmethacrylate, cellulose, rayon, pitch, polyvinylidene chloride, vinylidene chloride, polyvinyl chloride, phenolic resin, biomass, lignin, or melamine resin. The carbon material can be in the form of fibers, nanostructures, or sheets, with fibers or nanostructures such as nanoparticles being preferred. The carbon material can be processed to produce activated carbon nanostructures (e.g., substantially spherical nanoparticles) or fibers. Carbonized fibers can be obtained from various commercial source. A non-limiting example, of a commercial source of PAN-based carbon fibers is ZOLTEK™ (U.S.A). A non-limiting example, of a commercial source carbon nanoparticles is BAC® (JAPAN). In some embodiments, the carbon material can undergo an activation process after carbonization. In a preferred embodiment, the carbon material is activated polyacrylonitrile fibers or nanostructures. The activated PAN fibers or nanostructures can have a surface area of 1800 m²/g to 2600 m²/g, 1900 m²/g to 2500 m²/g, 2000 m²/g to 2400 m²/g, or 2100 m²/g to 2300 m²/g, or about 1800 m²/g, 1850 m²/g, 1900 m²/g, 1950 m²/gm 2000 m²/g, 2050 m²/g, 2100 m²/g, 2150 m²/g, 2200 m²/g, 2250 m²/g, 2300 m²/g, 2350 m²/g, or 2400 m²/g.

D. Applications

The carbon material-graphene composites of the present invention can be included in articles of manufacture, made into sheets, films, or incorporated into membranes. The sheet or film can have a thickness of 10 nm to 500 μm. The article of manufacture can be an energy storage device, a transport or conversion device, an actuator, a piezoelectric device, a sensor, a smart textile, a flexible device, an electronic device, an optical device, an optoelectronic device, an electro-optical device, a plasmonic device, a delivery device, a polymer nanocomposite, an actuating device, a MEMS/NEMS device, a logic device, a filtration/separation device, a capturing device, an electrochemical device, a display device, etc. In some embodiments, the article of manufacture is a virtual reality device, an augmented reality device, a fixture that requires flexibility such as an adjustable mounted wireless headset and ear buds, a communication helmet with curvatures, a medical patch, a flexible identification card, a flexible sporting good, a packaging material and applications where the energy source can simply final product design, engineering and mass production.

In some instances, the flexible composites of the present invention can enhance energy density and flexibility of flexible supercapacitors (FSC). The resultant flexible composites can include an open two-dimensional surface of graphene that can contact an electrolyte in the FSC. Moreover, the conjugated π electron (high-density carrier) of graphene can minimize the diffusion distances to the interior surfaces and meet fast charge-discharge of supercapacitors. Further, micropores of the composites of the present invention can strengthen the electric-double-layer capacitance, and mesopores can provide convenient pathways for ions transport.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Preparation of Activated Carbon Fiber

Air pre-oxidized fiber derived from polyacrylonitrile (PAN) was prepared (Institute of Coal and Chemistry, Chinese academy of science, PR China) and mixed with a saturated KOH solution (mass_{fiber}:mass_{KOH}=1:3) and then placed in a vertical tubular furnace. The obtained mixture was heated up to 800° C. at a heating rate of 3° C. min⁻¹ and then maintained at this temperature for 1 h under argon atmosphere with a flow rate of 60 ml min⁻¹. After cooling naturally to room temperature (about 15° C. to 30° C.), the obtained production was washed repeatedly with distilled water to remove the impurities, followed by drying at 100° C. for 12 h to obtain PAN-based activated carbon fiber (ACF).

### Example 2

### Preparation of Graphene Oxide

Graphene oxide was prepared by a modified Hummers' method (Hummers et al., J. Am. Chem. Soc., 1958, 80, 1339-1339) followed by ultra-sonication (600 W, 45 min) in deionized water to get the graphene oxide (GO) hydrosol with a concentration of 2.7 mg mL⁻¹.

### Examples 3-10

### Preparation of Grafted Graphene Oxide

General Procedure. Graphene oxide and grafting reactant were dissolved in the dimethylformamide (DMF) to obtain a homogeneous suspension. The mass ratio of Graphene oxide, grafting reactant and DMF was 1:25-30:200-280. The suspension was placed in a homogenizer reactor and heated at 100-120° C. for 8-12 hours to react the grafting agent with the graphene oxide. After cooling naturally to room temperature, the solution was centrifuged and the grafted graphene oxide was washed 3-5 times with deionized water to obtain grafted graphene oxide (Gft-GO). Specific grafting agents, graphene oxide properties, amounts of reactants, reaction time, and reaction temperature are listed in Table 1.

TABLE 1

| Example | | Graphene Oxide | | | DMF | Reaction | Reaction |
|---|---|---|---|---|---|---|---|
| No. | Grafting Agent (g) | Grams | Layers | Surface Area m²/g | (g) | Temp. (° C.) | Time (h) |
| 3 | Guanidine | 3 | 3 | 800 | 840 | 100 | 8 |
| | hydrochloride (75) | | | | | | |
| 4 | Phosphoguanidine (78) | 3 | 4 | 720 | 800 | 105 | 9 |
| 5 | Tetramethylguanidine | 3 | 5 | 600 | 750 | 110 | 10 |
| | (80) | | | | | | |
| 6 | Tetramethylguanidine | 3 | 5 | 600 | 700 | 115 | 11 |
| | trifluoromethane | | | | | | |
| | sulfonic acid (82) | | | | | | |
| 7 | Tetramethylguanidine | 3 | 4 | 720 | 680 | 120 | 12 |
| | hydrogen sulfate (84) | | | | | | |
| 8 | Oligo branched | 3 | 3 | 800 | 650 | 120 | 10 |
| | polyethylenimine (86) | | | | | | |
| 9 | Ethylenediamine (88) | 3 | 3 | 800 | 630 | 110 | 8 |
| 10 | Diethylenetriamine (90) | 3 | 5 | 600 | 600 | 100 | 10 |

### Example 11

### Preparation of Flexible PAN-Based Carbon Material-Graphene Composite Material from Graphene Oxide

GO hydrosol from Example 2 was mixed with ACF (54 mg, Example 1, mass_{ACF}:mass_{GO}=2:1) and sonicated for 10 min to get a homogeneous dispersion, followed by vacuum filtration on a microporous membrane to induce the sandwich assembly of GO flakes and ACF particles. The as-obtained composite films were peeled off from the membrane and shade dried for 2 h at room temperature. Subsequently, the composite films were placed in a graphite derived mold, and annealed to 950° C. at a heating rate of 5° C. min⁻¹ under argon atmosphere with a flow rate of 30 ml min⁻¹ and then held at this temperature for 30 min in a horizontal tubular furnace to reduce thermally GO to graphene (denoted as ACF-rGO-2).

### Example 12

### Preparation of Comparative Reduced Graphene Oxide Film from Graphene Oxide

For comparison, a graphene film (denoted as rGO) without ACF was prepared by a similar procedure. GO hydrosol from Example 2 (54 mg) was sonicated for 10 min to get a homogeneous dispersion, followed by vacuum filtration on a microporous membrane to induce the assembly of GO flakes. The film was peeled off from the membrane and shade dried for 2 h at room temperature. Subsequently, the film was placed in a graphite derived mold and annealed to 950° C. at a heating rate of 5° C. min⁻¹ under argon atmosphere with a flow rate of 30 ml min⁻¹ and then held at this temperature for 30 min in a horizontal tubular furnace to reduce thermally GO to graphene (denoted as rGO).

### Examples 13-20

### Preparation of PAN-Based Activated Carbon Material-Graphene Composite Using Grafted Graphene Oxide

General Procedure.

Grafted graphene oxide (1 g, Examples 3-10) and PAN-based activated carbon nanospheres with a specific surface area were mixed with ethanol by ultrasonic for 2 to 5 h (power: 500 W to 700 W) to obtain a well-dispersed suspension. Further, 100 ml of the above suspension was poured on watch glass with a specific diameter 10-25 cm. The composite film was formed on watch glass when the solvent evaporated completely. Subsequently, the composite film was sandwiched between two graphite plates, placed into a tubular furnace, annealed at temperature from 800° C. to 1200° C. at a heating rate of 3 to 5° C. min⁻¹ under argon atmosphere with a flow rate of 60 to 80 ml min⁻¹, and then held at 1200° C. for 0.5 h to 3 h. After cooling naturally to room temperature, the composite film of PAN-based activated carbon nanospheres/graphene was obtained. Table 2 presents the specific details of the reagents, reaction conditions, and annealing conditions.

TABLE 2

| | | PAN-Based Activated Carbon | | | | | Watch | | Argon | |
|---|---|---|---|---|---|---|---|---|---|---|
| | Gft-GO | | | Surface | | Ultrasonic | Glass | Annealing | Flow | Hold |
| Example | Example | Amt. | | Area | Ethanol | Time (h)/ | Diameter | Temp. (° C.) | Rate | Time |
| No. | No. | (g) | Type | (m²/g) | (g) | Power (W) | (cm) | and rate | (mL/min) | (h) |
| 13 | 3 | 1 | Nanospheres | 1800 | 200 | 2/500 | 15 | 800 at | 60 | 3 |
| | | | | | | | | 3° C./min | | |
| 14 | 4 | 2 | Nanospheres | 1900 | 220 | 3/600 | 15 | 850 at | 65 | 2 |
| | | | | | | | | 4° C./min | | |
| 15 | 5 | 3 | Nanospheres | 2000 | 240 | 4/700 | 15 | 900 at | 70 | 1 |
| | | | | | | | | 5° C./min | | |
| 16 | 6 | 3 | Nanospheres | 2100 | 260 | 5/500 | 20 | 950 at | 75 | 0.5 |
| | | | | | | | | 6° C./min | | |
| 17 | 7 | 4 | Fibers | 2200 | 280 | 4/600 | 20 | 1000 at | 80 | 1.5 |
| | | | | | | | | 5° C./min | | |
| 18 | 8 | 4 | Fibers | 2300 | 280 | 3/700 | 20 | 1100 at | 75 | 2.5 |
| | | | | | | | | 4° C./min | | |
| 19 | 9 | 1 | Fibers | 2400 | 270 | 5/600 | 25 | 1200 at | 70 | 3 |
| | | | | | | | | 3° C./min | | |
| 20 | 10 | 5 | Fibers | 2600 | 250 | 5/500 | 25 | 1000 at | 60 | 3 |
| | | | | | | | | 3° C./min | | |

### Example 21

### Textural Characterization of Examples 11-20

Scanning electron microscopy (SEM), atomic force microscope (AFM), and transmission electron microscopy (TEM) analysis.

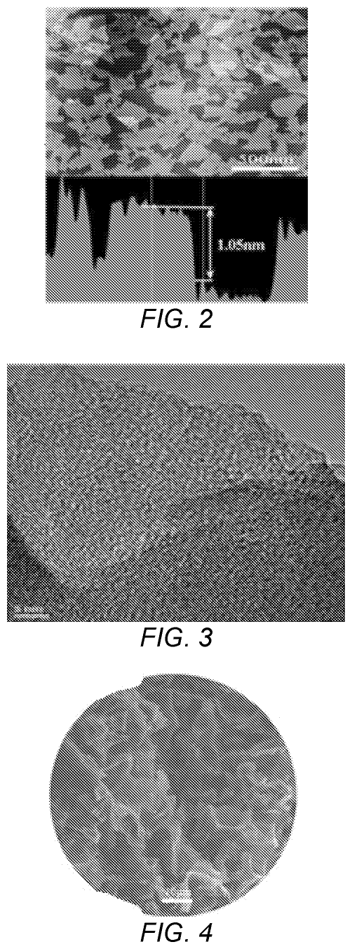

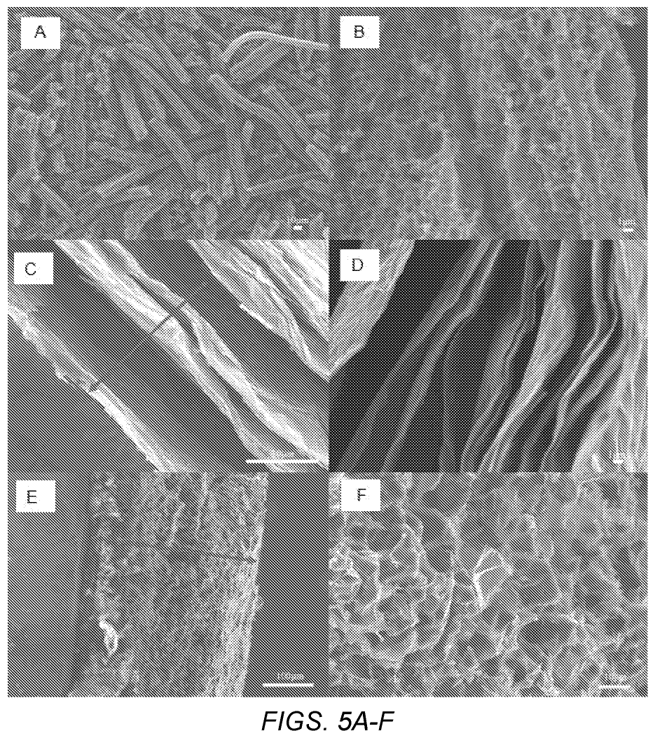

The morphologies of rGO, ACF and ACF-rGO-2 of the present invention were characterized by SEM, (JEOL JSM 7401F, Japan) at an accelerating voltage of 10 kV. The sheet size and thickness of the graphene oxide GO were investigated by atomic force microscope (AFM, Tip mode, Veeco NanoScope Ma Multimode, DI, USA). The microstructure of ACF was analyzed by transmission electron microscopy (TEM, FEI Tecnai G2 F20, USA) at an operating voltage of 200 kV. FIG. 2 is an AFM image of the Example 2 GO microstructures. FIG. 3 is a TEM image of Example 2 ACF. FIG. 4 is an SEM image of the ACF-rGO-2 film flexible film of the present invention. FIG. 5 are SEM images of (a and b) ACF, (c and d) rGO film, (e and f) ACF-rGO-2 film of the present invention.

The Example 1 ACF maintained its morphology of fibers, with a diameter of about 10 μm and varying lengths (FIG. 5A). Large amounts of macropores were observed (FIG. 5B), which resulted from the etching of KOH on the air pre-oxidized fiber at high temperature. Furthermore, the integral thickness of the Example 12 comparative rGO film was about 25 μm (FIG. 5C). Microscopically viewing, the lamellar thickness of graphene reaches several tens of nanometers, even hundreds of nanometers (FIG. 5D), indicating irreversible aggregation occurs due to overlapping of GO sheets. In contrast, ACF-rGO-2 film exhibited an obvious increasing thickness of about 300 μm due to the supporting role of ACF particles. Furthermore, FIGS. 5E AND 5F present the magnifying interface distribution characterization of ACF and graphene. Apart from ACF being coated by wrinkled graphene sheets and distributed uniformly in graphene, the re-stacking of graphene sheets reduced sharply. This was because larger amount of ACF insert among graphene sheets, thereby preventing the aggregation of graphene sheets more efficiently.

N₂ adsorption-desorption isotherms.

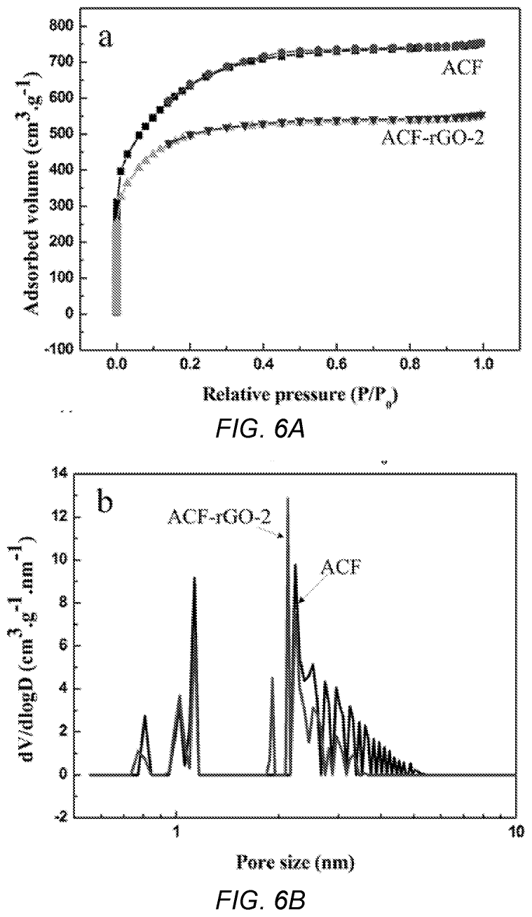

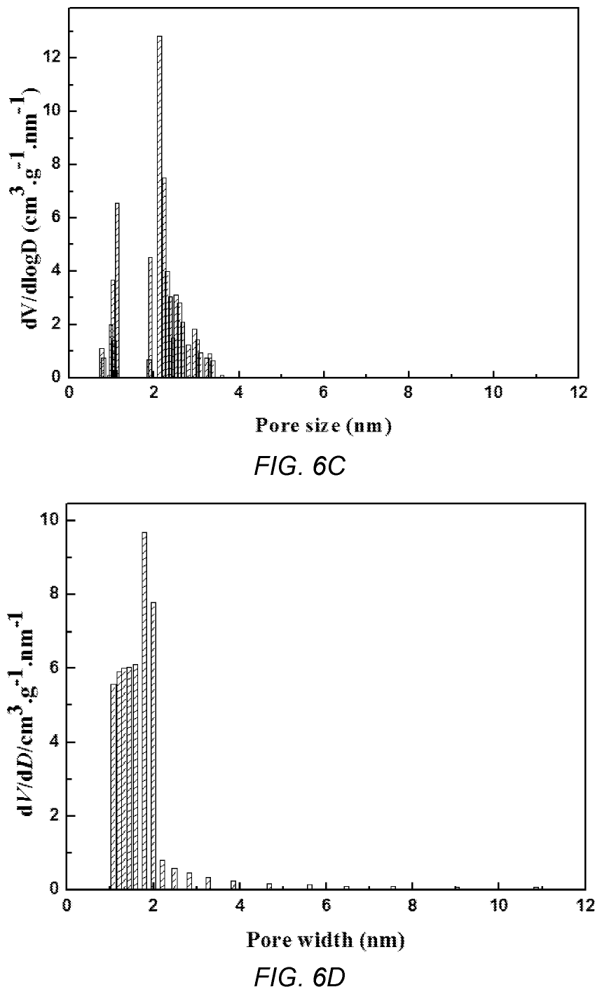

The specific surface area and pore structure of all samples comparative rGO film, ACF, and ACF-rGO-2 film were characterized by N₂ adsorption-desorption isotherms at 77 K (Micromeritics ASAP-2020). The specific surface area was obtained using Brunauer-Emmett-Teller (BET) method. The pore size distribution was calculated from the desorption branch of the nitrogen isotherm using density functional theory (DFT) method. The total pore volume (Vₜₒₜₐₗ) was calculated at the relative pressure of 0.99. Average pore size (L₀) was obtained using BJH method. Table 3 presents pore textural parameters of comparative rGO film, ACF, and ACF-rGO-2 composite film of the present invention. After calcination at 950° C. for 0.5 h, pure GO film was thermally reduced into rGO film with a specific surface area of 6 m² g⁻¹ and a total pore volume of 0.07 cm³ g⁻¹ (Table 3), indicating serious stacking for the comparative rGO film occurs during self-assembly. FIG. 6A shows N₂ adsorption-desorption isotherms and 6B shows DFT pore size distribution of ACF and ACF-rGO-2 of the present invention. As shown in FIG. 6A, both ACF and ACF-rGO-2 of the present invention exhibit the type IV isotherms with a wide hysteresis loops at a P/Po range from 0.35 to 0.99, which is characteristic of micro-mesoporous materials. In order to further analyze the porous structure of ACF and ACF-rGO-2 of the present invention, the pore size distribution derived using nonlocal density functional theory (DFT) is given in FIG. 6B. Both ACF and ACF-rGO-2 of the present invention are characteristic of bimodal porous structure composed of micropores (0.8-1.2 nm) for charge storage and mesopores (2-5 nm) for providing fast ion diffusion pathways. The specific surface area of ACF-rGO-2 flexible film of the present invention was 1761 m² g⁻¹ and had a highly developed porous structure. Such a structure can be beneficial for charge storage. FIG. 6C shows a pores size distribution of activated carbon derived from PAN fiber (Example 1), which shows a bimodal distribution of pores. FIG. 6D shows a pore size distribution of comparative activated carbon derived from petrol coke, which show a monomodal distribution of pores.

TABLE 3

| Example | | SBET^{a} | Smicro^{b} | Vtotal^{c} | Vmicro^{d} | L0^{e} | Conductivity^{f} |
|---|---|---|---|---|---|---|---|
| No. | Description | m² · ⁻¹ | m² · ⁻¹ | cm³ · ⁻¹ | cm³ · ⁻¹ | nm | S · cm⁻¹ |
| 12 | rGO | 6 | — | 0.07 | — | 51.22 | 130.6 |
| 11 | ACF-rGO-2 | 1761 | 653 | 0.86 | 0.28 | 1.95 | 4.36 |
| 13 | grafted | 1520 | — | — | — | — | 5.4 |
| 14 | grafted | 1680 | — | — | — | — | 9.8 |
| 15 | grafted | 1710 | — | — | — | — | 27 |
| 16 | grafted | 1760 | — | — | — | — | 35 |
| 17 | grafted | 2000 | — | — | — | — | 18 |
| 18 | grafted | 2150 | — | — | — | — | 22 |
| 19 | grafted | 1740 | — | — | — | — | 40 |
| 20 | grafted | 2240 | — | — | — | — | 5 |

^{a}BET surface area;
^{b}Micropore surface area;
^{c}Total pore volume, measured at P/P0 = 0.99;
^{d}Micropore volume;
^{e}Average pore size;
^{f}ACF was measured by power resistivity meter, rGO and ACF-rGO-2 was measured by four probe resistivity meter.

Thermal Gravimetric Analysis (TGA).

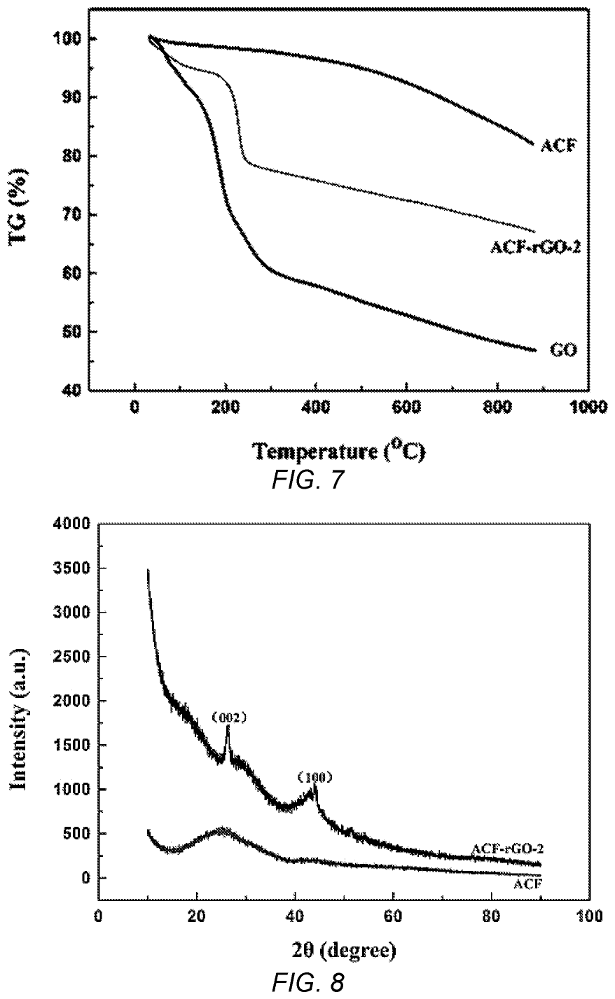

Thermogravimetric (TG) analyses of graphene oxide (GO) and Examples 1 (ACF) and 12 (ACF-rGO-2) were obtained using a Perkin-Elmer TG/DTG-6300 instrument (Perkin-Elmer, U.S.A.) in a temperature range of 30-880° C. at a heating rate of 5° C. min⁻¹ under argon atmosphere with a flow rate of 40 ml min⁻¹. TG analysis of GO, ACF, and ACF-rGO-2 in an argon atmosphere was employed to exhibit the structural evolution during annealing. FIG. 7 shows TGA curves of GO, ACF, and ACF-rGO-2 of the present invention. As shown in FIG. 7, a gradual decrease in the weight loss curve for ACF was observed. However, both GO and ACF-rGO-2 exhibited weight loss in three stages. In the initial stage at a temperature below 150° C., the weight loss was ascribed to the loss of adsorbed atmospheric gases (CO2 and H2O). In the intermediate stage at about 230° C., a maximum weight loss occurred, corresponding to the removal of terminal oxygen-containing groups of GO. In the final stage above 230° C., the weight loss was attributed to polycondensation of as-obtained materials. Moreover, the carbon retention at 880° C. for Example 2 GO, Example 1 ACF and Example 11 ACF-rGO-2 of the present invention reached 46.9%, 82.0% and 67.1%, respectively.

X-ray diffraction analysis.

The transition of crystal plane for ACF (Example 1) and ACF-rGO-2 of the present invention (Example 12) was investigated by XRD using a D8 ADVANCE A25 (Bruker, Germany) with CuKa₁ radiation (λ=1.5418 Å)). FIG. 8 shows the XRD patterns for Example 1 ACF and Example 11 ACF-rGO-2 of the present invention. Referring to FIG. 8, the as-obtained ACF only exhibited a broad (002) diffraction peak at 20=26°, which was characteristic of an amorphous structure due to the destruction of KOH activation on the microcrystalline structure of ACF. In comparison with ACF, two relative sharp diffraction peaks for ACF-rGO-2 of the present invention at 2θ=26° and 43° were assigned to the crystal plane of (002) and (100), which indicated the introduction of graphene rendering high degree of orientation for the flexible carbon film.

### Example 22

### Electrical Property Analysis

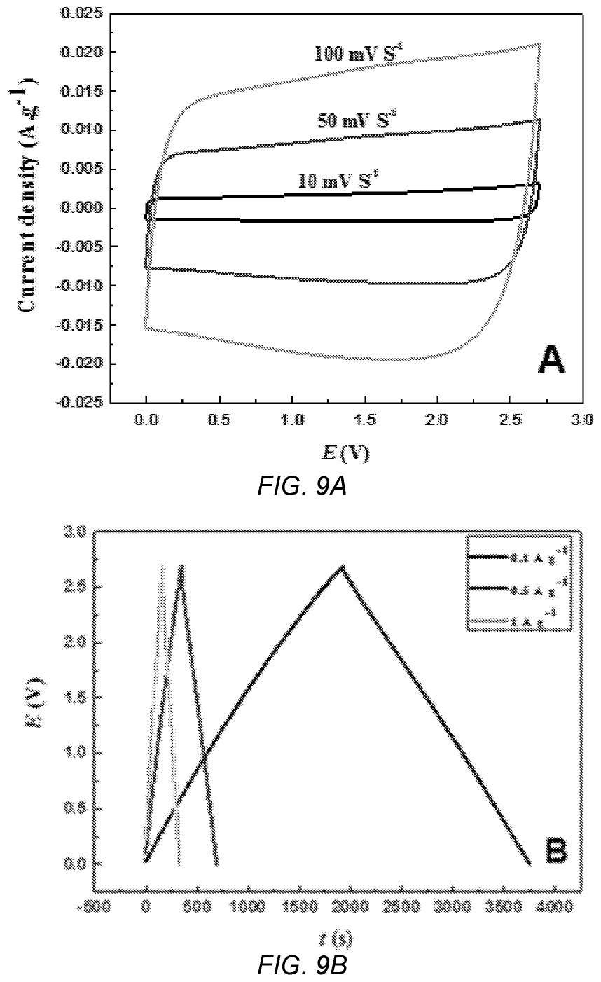

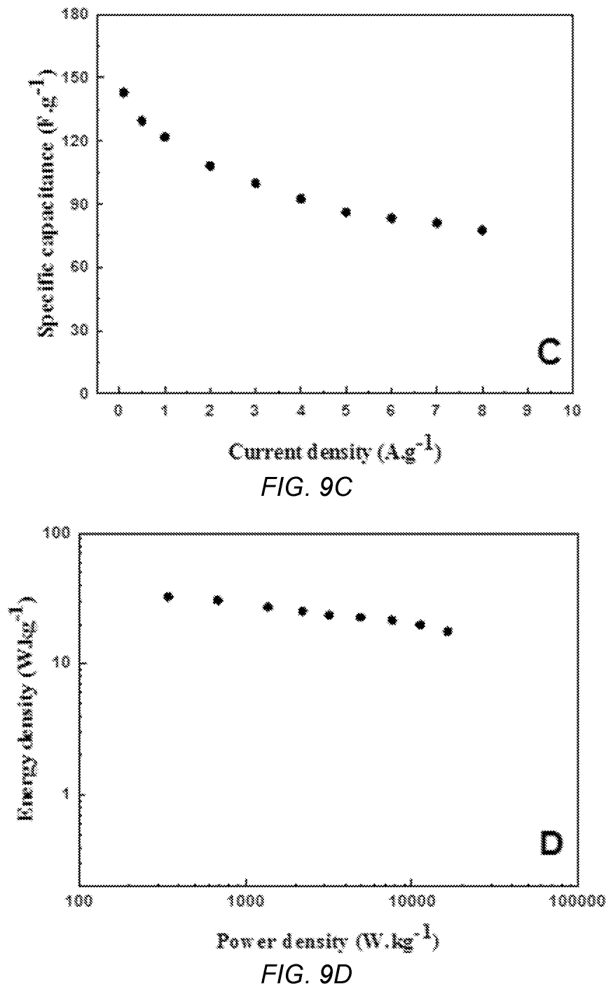

The capacitive performance of the flexible film of the present invention was evaluated by CV and GCD in the two-electrode system, with 1.0 M Et₄NBF₄/PC as the designated electrolyte. FIGS. 9A-D shows the electrochemical performance of the as-fabricated flexible supercapacitor (ACF-rGO-2 composite material of the present invention, Example 11) with 1.0 M Et₄NBF₄/PC as the electrolyte. FIG. 9a: CV curves of ACF-rGO-2 of the present invention at a voltage window range from 0 to 2.7 at different scan rates. FIG. 9b: GCD curves of ACF-rGO-2 of the present invention at different current densities. FIG. 9c specific capacitance vs. current densities for ACF-rGO-2 of the present invention. FIG. 9d: power density vs. energy density for ACF-rGO-2 of the present invention. Referring to FIG. 9a, the shape of the CV curves for ACF-rGO-2 in a voltage range from 0 to 2.7 V at a scan rate range from 10 to 50 mV s⁻¹ is shown. All CV curves were close to the ideal rectangular shape, being a characteristic of pure electric double-layer capacitance. Furthermore, it was seen from the GCD curves (FIG. 9b) that the linear potential-time dependence demonstrates the typical double-layer capacitive behavior of the cell. Based on the discharging curve line, the specific capacitance was calculated according to the formula: C=IΔt/Δm V, where C, I, V, Δt and Δm are the gravimetric capacitance (F g⁻¹), the constant discharging current (A), the cell voltage (V), the discharge time (s) and the mass of the material (g). The specific capacitance for ACF-rGO-2 (Example 11) was calculated to be 122 F g⁻¹ at a current density of 1 A g⁻¹, a high storage capacity. More importantly, at a high rate of 8 A g⁻¹ (FIG. 9c), the resultant ACF-rGO-2 maintained 63.6% retention of its initial specific capacitance measured at 1 A g⁻¹. The good rate capability for ACF-rGO-2 of the present invention can be ascribed to the introduction of graphene, rendering a high conductivity of 4.36 S cm⁻¹ comparable to those of ACF (See, Table 3).

As illustrated by FIG. 9d, the power and energy densities were calculated by means of GCD of a flexible supercapacitor using a voltage window of 2.7 V and current densities between 0.1 and 8 A g⁻¹. The energy and power densities can be written, respectively, as: E=CV²/2 and P=E/Δt, where C, V, and Δt are the gravimetric capacitance, the cell voltage, and the discharge time. Using the specific capacitance value of 122 F g⁻¹ derived the discharge curve at a current density of 1 A g⁻¹ and working voltage of 2.7 V, the obtained energy density was 30.8 Wh kg⁻¹ for ACF-rGO-2 of the present invention in the flexible device. At a short current drain time of 6.4 s, the obtained energy density was still up to 20 Wh kg⁻¹ for ACF-rGO-2 of the present invention at a power density of 11.3 kW kg⁻¹. A comparison of known energy and power densities and the ACF-rGO-2 composite of the present invention are shown in Table 4. From comparison of the data, the energy and power densities of ACF-rGO-2 of the present invention are relatively superior comparable to those of the flexible films derived other carbon materials.

TABLE 4

| | | Energy | Power | |
|---|---|---|---|---|
| | | density | density | |
| Samples | Electrolyte | (Wh kg⁻¹) | (kW kg⁻¹) | Reference |
| CLCF | PVA/H₃PO₄ gel | 5.9 | 1.2 | a |
| CNT | EMIMNTf₂ | 21.1 | 3.0 | b |
| SWCNT | LiPF₆/EC:DEC | 6.0 | 70 | c |
| SWCNT | 1.0M H₂SO₄ | 3.8 | 7 | d |
| e-CMG | 1.0M Na₂SO₄ | 6.5 | 2.4 | e |
| HPNCNF | 6M KOH | 3.75 | 10 | f |
| TRGO/fabric | PVA/H₃PO₄ gel | 5.8 | 27.7 | g |
| ACF-rGO-2 | 1.0M Et₄NBF₄/PC | 20.0 | 11.3 | Example 22 |

a: Cheng et al., Nano Energy, 2015, 15, 66-74,
b: Kang et al., Appl. Surf. Sci., 2015, 355, 160-165,
c: Kaempgen et al., Nano Lett., 2009, 9, 1872-1876,
d: Wang et al., J. Mater. Chem., 2011, 21, 16373-16378,
e: Choi et al., ACS Nano, 2012, 6, 4020-4028,
f: Huang et al., Mater. Chem. Phys., 2016, 169, 1-5,
g: Ramadoss et al., Nano Energy, 2015, 15, 587-597.

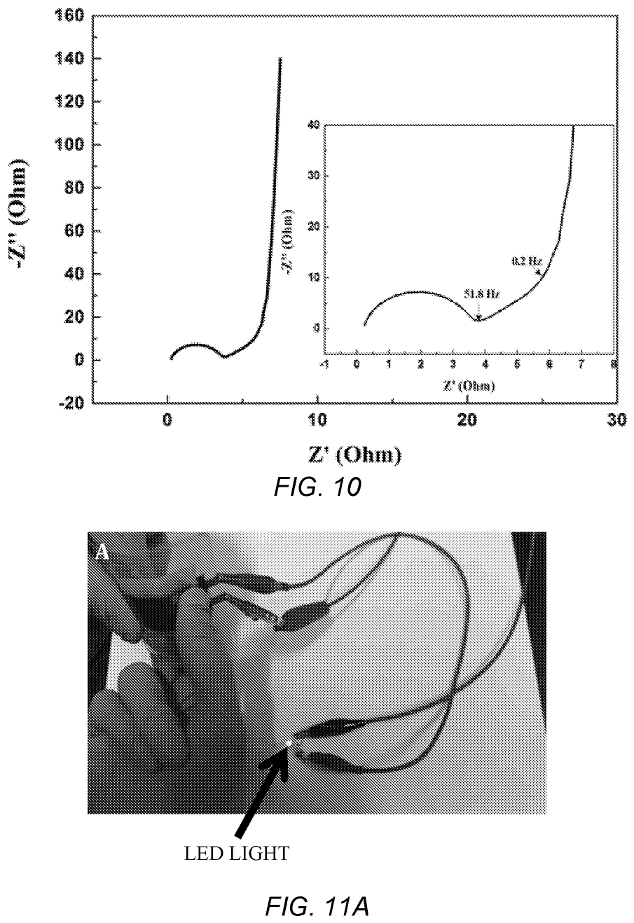

In addition, electrochemical impedance spectroscopy (EIS) experiments were performed in the frequency range from 0.01 to 10⁵ Hz, with an AC amplitude voltage of 5 mV. FIG. 10 depicts Nyquist plots of ACF-rGO-2 of the present invention (Example 11) in the frequency range from 0.01 Hz to 10⁵ Hz. As shown in FIG. 10, the Nyquist plot of ACF-rGO-2 of the present invention shows a relative small semicircle at high frequency, followed with a transition to linearity closed to 45° at medium frequency and a line vertical to the real axis at low frequency. It is well accepted that the imaginary part increased sharply and almost vertical line at low frequency indicated the ideal capacitive behavior of the as-obtained materials. The magnified data in the high frequency is shown in the inset of FIG. 10. The intercept at the real axis in high frequencies was the equivalent series resistance value of about 0.24Ω, exhibiting good electrical conductivity. The smaller semi-circle reflecting the interfacial electronic resistance in high frequency for ACF-rGO-2 of the present invention implies fast ion diffusion inside the porous structure of ACF-rGO-2 of the present invention.

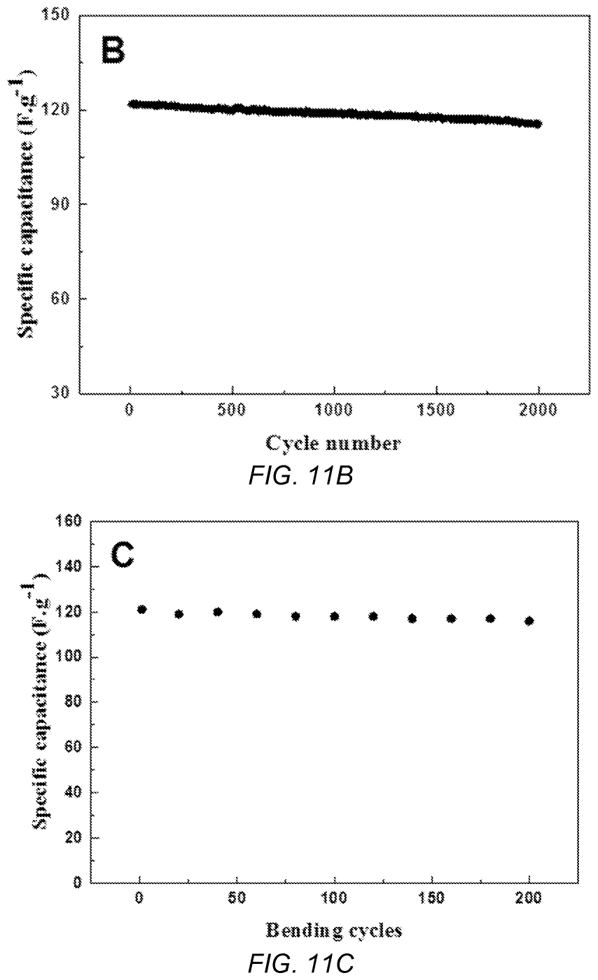

To evaluate the practical applications for the ACF-rGO-2 flexible film of the present invention, a packaged flexible device was assembled. FIG. 11A is an image for flexible supercapacitor lighting an LED bulb. FIG. 11B shows cycling stability of ACF-rGO-2 at a current density of 1 A g⁻¹. FIG. 11C shows specific capacitance vs. bending cycles for ACF-rGO-2. As shown in FIG. 11A, the flexible device at a bending angle of about 90° lit an LED bulb. Moreover, the stability experiment of the ACF-rGO-2 flexible device of the present invention was further investigated by the GCD between 0 and 2.7 V at a current density of 1 A g⁻¹ (FIG. 11B). After 2000 cycles, the specific capacitance of the packaged flexible device decreased from 121.8 F g⁻¹ to 115.5 F g⁻¹, a retention ratio of 94.8% of its initial capacitance, displaying an excellent cycling durability for ACF-rGO-2 composite of the present invention. Notably, the specific capacitance for the flexible ACF-rGO-2 composite device almost remains the same under a continuous bending from 0 to 90° for 200 cycles (FIG. 11C), indicating a perfect mechanical strength for ACF-rGO-2 composite of the present invention.

The flexible carbon film of the present invention, synthesized by a vacuum-assisted evaporation of the solvent at room temperature and subsequent anneal in which graphene oxide and activated carbon fiber were used as the composite materials, have high surface area, high conductivity, and are flexible. In a preferred example, a mass ratio of activated carbon fiber to graphene oxide of 2, produced a flexible carbon material-graphene composite having a high specific surface area of 1761 m² g⁻¹, high conductivity of 4.36 S cm⁻¹ and excellent flexibility for flexible carbon film. In addition, the constructed flexible supercapacitors made from the carbon material-graphene composite of the present invention exhibited a high specific capacitance of 122 F g⁻¹ at a current density of 1 A g⁻¹, energy density of 20 Wh corresponding to power density of 11.3 kW kg⁻¹, excellent rate capability, and good cycle stability.

1. A method for producing a carbon material-graphene composite, the method comprising:
(a) obtaining a dispersion comprising a graphene oxide material and a carbon material dispersed in a liquid medium;
(b) evaporating the liquid medium to form a carbon material-graphene composite precursor; and
(c) annealing the composite precursor at a temperature of 800° C. to 1200° C. in the presence of an inert gas to form the carbon material-graphene composite.

2. The method of claim 1, wherein the carbon material is a polyacrylonitrile (PAN)-based carbon material.

3. The method of claim 1, wherein the graphene oxide material has a lamellar thickness of 3-5 layers and a specific surface area of 600-800 m²/g.

4. The method of claim 1, wherein the graphene oxide material is grafted graphene oxide or graphene oxide

5. The method of claim 4, wherein the grafted graphene oxide is obtained by:
(i) subjecting a composition comprising a solvent, graphene oxide, and a grafting agent to conditions sufficient to produce a grafted graphene oxide; and
(ii) removing the grafted graphene oxide from the solution.

6. The method of claim 5, wherein the grafting agent comprises an ionic liquid or a poly-amino compound, or both.

7. The method of claim 2, wherein the PAN-based carbon material is PAN-based carbon nanostructures, PAN-based carbon fibers, or both.

8. The method of claim 7, wherein the specific surface area of PAN-based carbon nanostructures or PAN-based carbon fibers is 1800 to 2600 m²/g.

9. The method of claim 1, wherein the liquid medium is an alcohol, preferably methanol, ethanol, propanol, butanol or combinations thereof.

10. The method of claim 1, wherein step (b) further comprises:
(i) casting the solution on a substrate; and
(ii) evaporating the liquid medium.

11. The method of claim 1, wherein step (b) promotes self-assembly of the grafted graphene oxide and the carbon material.

12. A flexible carbon material-graphene composite comprising PAN-based activated carbon attached to a graphene layer, wherein the composite has:
(a) a surface area of 1500 m²/g to 2250 m²/g; and
(b) a bimodal porous structure of micropores and mesopores.

13. The flexible carbon material-graphene composite of claim 12, wherein the material is a flexible film or sheet.

14. The flexible carbon material-graphene composite of claim 12, wherein the average size of the micropores are 0.8 nm to 1.2 nm and the average size of the mesopores are 2 nm to 5 nm.

15. The flexible carbon material-graphene composite of claim 12, wherein the composite is binder-free and/or support-free.

16. The flexible carbon material-graphene composite of claim 12, wherein the composite comprises at least two graphene layers that are attached to one another through the PAN-based carbon material.

17. The flexible carbon material-graphene composite of claim 16, wherein the PAN-based activated carbon is positioned between the two graphene layers.

18. The flexible carbon material-graphene composite of claim 12, wherein the composite has:
an electrical conductivity of 1 S/cm to 45 S/cm, preferably 4 S/cm to 40 S/cm;
an energy density of 10 Wh/kg to 40 Wh/kg, preferably 15 Wh/kg to 35 Wh/kg, or more preferably about 20 Wh/kg;
a power density of 5 kW/kg to 15 kW/kg; and/or
a specific capacitance of 100 F/g to 140 F/g, preferably 110 F/g to 130 F/g.

19. The flexible carbon material-graphene composite prepared by the method of claim 1.

20. An energy storage device comprising the carbon material-graphene composite of claim 12, wherein the energy storage device is a capacitor, a supercapacitor, or a rechargeable battery, preferably a lithium-ion or lithium sulfur battery.
